(19) United States
(12) Patent Application Publication
(10) Pub. No.: US 2019/0253378 A1
(43) Pub. Date: Aug. 15, 2019

(54) INSTANT MESSAGING METHOD AND DEVICE

(71) Applicant: BEIJING KINGSOFT INTERNET SECURITY SOFTWARE CO., LTD., Beijing (CN)

(72) Inventor: Baozhen Gu, Beijing (CN)

(73) Assignee: BEIJING KINGSOFT INTERNET SECURITY SOFTWARE CO., LTD., Beijing (CN)

(21) Appl. No.: 16/395,582

(22) Filed: Apr. 26, 2019

Related U.S. Application Data
(63) Continuation of application No. PCT/CN2017/106372, filed on Oct. 16, 2017.

(30) Foreign Application Priority Data
Jun. 23, 2017 (CN) 201710485602.4

(51) Int. Cl. H04L 12/58

(52) U.S. Cl. CPC H04L 51/24; H04L 51/02; H04L 51/04

(57) ABSTRACT

The present invention discloses an instant messaging method and device. The instant messaging method is applicable to an electronic equipment in a screen locked state, and includes: monitoring a notification message in a message notification bar; extracting key information of the notification message from the monitored notification message; determining, according to the key information, whether the notification message is a message requiring a reply; if the notification message is a message requiring a reply, displaying a reply interface for a user on the electronic equipment, wherein the reply interface is independently configured and used to provide a uniform reply entry for multiple applications; generating a reply message to the notification message in the reply interface, and sending the reply message to the application, so as to enable the application to send the reply message to an application of a receiving party.

### CROSS-REFERENCE TO RELATED APPLICATIONS

This application is a continuation application of International application No. PCT/CN2017/106372, filed on Oct. 16, 2017, which claims priority to and benefits of Chinese Patent Application Serial No. 201710485602.4, filed on Jun. 23, 2017, and titled with “Instant messaging method and device” by Beijing KINGSOFT INTERNET SECURITY SOFTWARE CO. LTD, the entire content of which is incorporated herein by reference.

### FIELD

The present disclosure relates to communication technology field, and more particularly, to an instant messaging method and device.

### BACKGROUND

With the continuous development of the Internet and hardware such as electronic equipment, the social needs of users are also increasing, more and more social applications are produced, and each application's notification messages are displayed in a notification bar to remind users to view the notification message. In the related art, when receiving the notification messages, the electronic equipment categorizes and processes notification messages popped-up by the same application, and displays all notification messages corresponding to each application in a notification bar. The user can only enter the application by clicking the notification message in the corresponding notification bar, and then can reply to the above notification message in the application.

In this way, the user needs to click on the notification message in the notification bar and enters the corresponding application to reply to the message, especially when the notification bar receives notification messages from multiple applications, if the user attempts to reply to the notification messages, he needs to return to the notification bar after he replies to the notification message of one application, then clicks on another notification message of another application and enters the application. As a result, the user needs to jump between multiple applications, such that processing steps are cumbersome, and message processing efficiency is low.

### SUMMARY

Embodiments of the present disclosure aim to solve at least one of the technical problems in the related art to at least some extent.

Embodiments of a first aspect of the present disclosure provide an instant messaging method, applicable to an electronic equipment in a screen locked state, and including: monitoring a notification message in a message notification bar, wherein the notification message comes from an application installed on an electronic equipment; extracting key information of the notification message from the monitored notification message; determining whether the notification message is a message requiring a reply according to the key information; if the notification message is a message requiring a reply, displaying a reply interface for a user on the electronic equipment, wherein the reply interface is independently configured and used to provide a uniform reply entry for multiple applications; generating a reply message to the notification message in the reply interface, and sending the reply message to the application, such that the application sends the reply message to an application of a receiving party.

Embodiments of a second aspect of the present disclosure provide an instant messaging device, which is applicable to an electronic equipment in a screen locked state, and includes a processor and a memory. The memory is configured to store instructions executable by the processor. The processor is configured to run a program corresponding to the instructions by reading the instructions stored in the memory, so as to perform the instant messaging method according to embodiments of the first aspect.

Embodiments of a third aspect of the present disclosure provide an electronic equipment, including a housing, a processor, a memory, a circuit board and a power supply circuit, wherein, the circuit board is disposed in a space enclosed by the housing, the processor and the memory are positioned on the circuit board; the power supply circuit is configured to provide power for respective circuits or components of the electronic equipment; the memory is configured to store executable program codes; the processor is configured to run a program corresponding to the executable program codes by reading the executable program codes stored in the memory, to perform the instant messaging method according to embodiments of the first aspect.

In order to achieve the above objectives, embodiments of a fourth aspect of the present disclosure provide a computer program product. When instructions in the computer program product are executed by a processor, the instant messaging method according to embodiments of the first aspect is performed.

In order to achieve the above objectives, embodiments of a fifth aspect of the present disclosure provide a non-transitory computer readable storage medium, configured to store computer programs that, when executed by a processor, implement the instant messaging method according to embodiments of the first aspect.

Additional aspects and advantages of embodiments of the present disclosure will be given in part in the following descriptions, become apparent in part from the following descriptions, or be learned from the practice of embodiments of the present disclosure.

### BRIEF DESCRIPTION OF THE DRAWINGS

In order to clearly illustrate technical solutions of embodiments of the present disclosure, a brief description of drawings used in embodiments is given below Obviously, the drawings in the following descriptions are only part embodiments of the present disclosure, and for those skilled in the art, other drawings can be obtained according to these drawings without creative labor.

FIG. 1 is a flow chart of an instant messaging method according to embodiments of the present disclosure.

FIG. 2 is a flow chart of another instant messaging method according to embodiments of the present disclosure.

FIG. 3 is a flow chart of another instant messaging method according to embodiments of the present disclosure.

FIG. 4 is a flow chart of another instant messaging method according to embodiments of the present disclosure.

FIG. 5 is a block diagram of an instant messaging device according to embodiments of the present disclosure.

FIG. 6 is a block diagram of another instant messaging device according to embodiments of the present disclosure.

FIG. 7 is a block diagram of an electronic equipment according to embodiments of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. Embodiments described herein with reference to drawings are explanatory, serve to explain the present disclosure, and are not construed to limit embodiments of the present disclosure.

The instant messaging method and device according to embodiments of the present disclosure will be described below with reference to the accompanying drawings.

FIG. 1 is a flow chart of an instant messaging method according to embodiments of the present disclosure. The instant messaging method can be applied to an electronic equipment in a screen locked state, wherein, the electronic equipment may be, for example, a PC (Personal Computer), a cloud equipment or a mobile equipment, such as a smart phone or a tablet computer.

As illustrated in FIG. 1, the instant messaging method includes followings.

At S101, a notification message in a message notification bar is monitored, in which the notification message comes from an application installed on an electronic equipment.

Currently, a notification bar can be provided on the electronic equipment, in which the notification message can be displayed to the user, so that the user can quickly learn about the content of the notification message and the sender. Since the notification message in the notification bar can be a system type message, an instant messaging type message, a news type message, a payment type message, and the like, the notification message in the message notification bar can be monitored in real time to determine whether the notification message is an instant messaging type message, that is, whether the notification message is a message requiring a reply.

At S102, key information of the notification message is extracted from the monitored notification message.

Optionally, the notification message in the notification bar is monitored and a notification object of the notification message is obtained from the monitored notification message, then, the key information of the notification message is extracted from the notification object, to determine whether the notification message is a message requiring a reply or not according to the key information.

In embodiments of the present disclosure, the key information includes a message identification code of the notification message, a package name of the notification message, a data storage container of the notification message, text information of the notification message, and an action set of the notification message, a tag of the notification message and/or a receiving time of the notification message, and so on.

The message identification code of the notification message may uniquely identify the notification message, and the message identification code of the notification message may be for example an ID of the notification message, or any character that distinguishes the notification message from other messages, which is not limited here.

The package name of the notification message, i.e., packageName, can indicate the application to which the notification message corresponds and the specific object to chat with in the application.

The data storage container of the notification message, i.e., Bundle, is configured to store the notification message and the reply message.

The action set of the notification message, i.e., mActions, traverses the set of actions of the notification message, and determines whether the notification message is a message requiring a reply.

The tag of the notification message is marked as Tag.

The receiving time of the notification message is marked as Time.

Optionally, the key information may further include whether the notification message is a message sent by the user (isSend), whether the notification message is a group chat message (isGroupChat), a group chat message title (groupChatTitle), and text information of the group chat message (groupChatContent).

At S103, it is determined whether the notification message is a message requiring a reply according to the key information.

For example, the action set of the notification message (mActions) may be traversed to determine whether an input action is included in the action set of the notification message (mActions), that is, the input action is searched for in the mActions. If no input action is found in the mActions, it indicates that the notification message is a message that does not require a reply, and no processing can be performed at this time. If the input action is found in the mActions, it indicates that the notification message is the message requiring a reply, at this time, the subsequent steps can be triggered.

At S104, if the notification message is a message requiring a reply, a reply interface is displayed for a user on the electronic equipment, in which the reply interface is independently configured and used to provide a uniform reply entry for multiple applications.

Optionally, when the notification message is a message requiring a reply, the reply interface is displayed for the user on the electronic equipment, which can facilitate the user to reply quickly, and effectively improve the social experience of the user. When the notification message is a message that does not require a reply, no processing can be performed, which can save the power consumption of the system and increase the battery life of the electronic equipment.

At S105, a reply message to the notification message is generated in the reply interface, and the reply message is sent to the application, such that the application sends the reply message to an application of a receiving party.

Optionally, the user can write the reply message of the notification message in the reply interface, and the application can send the reply message to the server of the application after receiving the reply message, and then the server forwards the reply message to the application of the receiver.

For, example, in a social application, such as WeChat, the electronic equipment of user A is in a screen locked state. User B wants to chat with user A. In this case, user B sends a message to user A. After the electronic equipment of user A receives the message, as the electronic equipment of user A is in the screen locked state, the electronic equipment of user A can detect the message and display the message in the notification bar to notify user A that the message can be viewed in the notification bar. After user A clicks the message, he can enter the unified reply entry and write corresponding reply message. The WeChat of user A can send the reply message to the server of WeChat after receiving the reply message written by user A, and then the server forwards the reply message to the WeChat of user B. In this way, fast chat is achieved.

The instant messaging method according to embodiments of the present disclosure monitors the notification message in the message notification bar, extracts key information of the notification message from the monitored notification message, determines whether the notification message is a message requiring a reply according to the key information, displays the reply interface for the user on the electronic equipment if the notification message is a message requiring a reply, generates the reply message to the notification message in the reply interface, and sends the reply message to the application, such that the application sends the reply message to an application of a receiving party. In the present embodiments, a uniform reply interface is provided for multiple applications, such that it is possible to quickly reply to notification messages from multiple applications, improving message processing efficiency, and improving the social experience of the user.

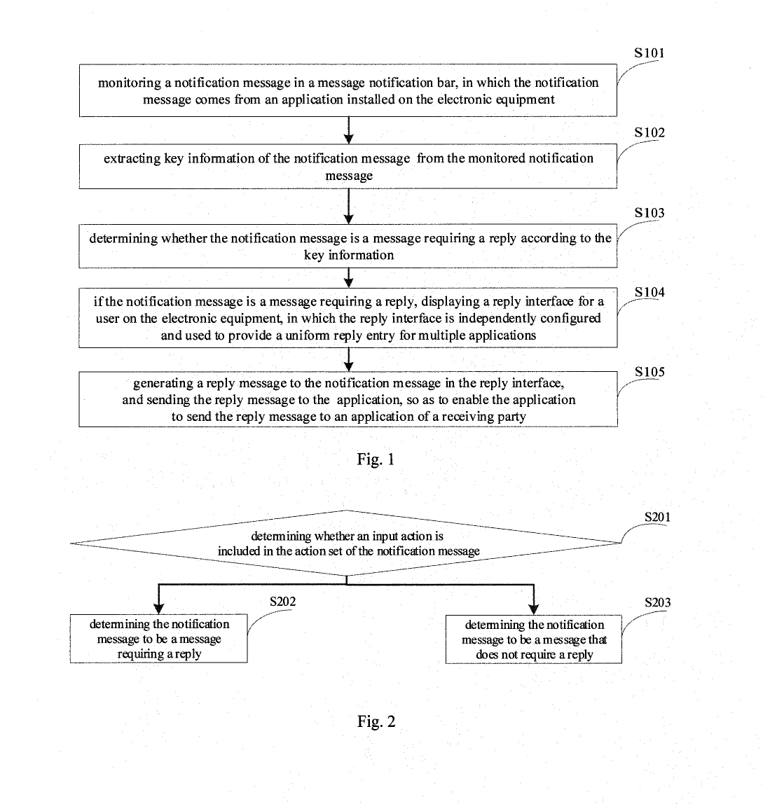

To further improve the social experience of the user, referring to FIG. 2, on the basis of the embodiment as illustrated in FIG. 1, step S103 specifically includes the following sub-steps.

At S201, whether an input action is included in the action set of the notification message is determined, if yes, S202 is executed, otherwise, S203 is executed.

Optionally, the action set of the notification message (mActions) may be traversed to determine whether an input action is included in the action set of the notification message (mActions), that is, the input action is searched for in the mActions, If no input action is found in the mActions, it indicates that the input action is not included in the action set of the notification message; if the input action is found in the mActions, it indicates that the input action is included in the action set of the notification message.

At S202, the notification message is determined to be a message requiring a reply.

if the action set includes the input action, the notification message is determined to be a message requiring a reply. In this case, the reply interface can be displayed to the user on the electronic equipment, to improve the social experience of the user.

At S203, the notification message is determined to be a message that does not require a reply.

if the action set does not include the input action, the notification message is determined as a message that does not require the reply. In this case, no processing can be performed, that is, the reply interface is not displayed to the user on the electronic equipment, which can save the power consumption of the system and increase the battery life of the electronic equipment.

According to the instant messaging method of the present embodiment, when the action set includes the input action, the notification message is determined as the message requiring the reply, which may improve the social experience of the user. When the action set does not include the input action, the notification message is determined as the message that does not require the reply, and in this case, no processing can be performed, which may save the power consumption of the system and increase the battery life of the electronic equipment.

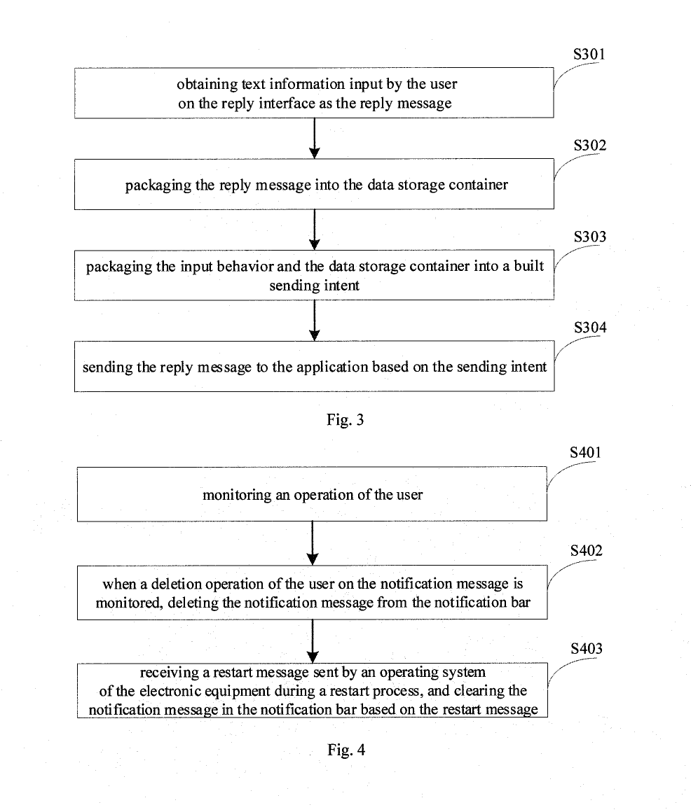

In order to clearly illustrate the above embodiments, referring to FIG. 3, on the basis of the embodiment as illustrated in FIG. 1, step S105 specifically includes the following sub-steps.

At S301, text information input by the user on the reply interface is obtained as the reply message.

In the embodiment, the text information may include characters, symbols and/or emojis, etc.

At S302, the reply message is packaged into the data storage container.

After obtaining the reply message, the reply message can be packaged into the data storage container, that means, the characters, symbols, and/or emojis written by the user are stored in the data storage container (Bundle). In the embodiment, a reply channel corresponding to the application used by the user can be obtained according to the data storage container, thereby enabling the reply message to be sent to the corresponding application through the data storage container.

At S303, the input action and the data storage container are packaged into a built sending intent.

Optionally, the built sending intent, for example, intent, can be created in the memory of the electronic equipment. After the input action and the data storage container (Bundle) are packaged in the built sending intent, the Notification object of this notification message will be kept in the memory of the electronic equipment. This Notification object allows the user to continuously reply to messages, that is, the user can reply and receive new messages continuously for a certain session on the reply interface, making it maintain the same user experience as the local social application.

At S304, the reply message is sent to the application based on the sending intent.

As an example, when a Cheetahmobile Locker (CM Locker) is installed on the electronic equipment of the user, and when the user starts the CM Locker and the screen is off, the lock screen interface will be started. When the user receives a notification message, the notification message is displayed on the lock screen, and if this message is determined to be stored in the input action, a unified reply entry will be displayed, and the user can click the reply entry to enter the reply details page. Afterwards, the user can input characters, symbols, and/or emojis in the input box of the reply details page, and finally click the send button to reply to the notification message.

With the instant messaging method according to embodiments of the present disclosure, by obtaining the text information input by the user on the reply interface as the reply message, packaging the reply message into the data storage container, packaging the input action and the data storage container into the built sending intent, and sending the reply message to the application based on the sending intent, a unified reply interface can be provided for multiple applications, such that it is possible to quickly reply to notification messages of multiple applications on the reply interface, thus improving the efficiency of message processing as well as improving the social experience of the user.

To illustrate the above embodiment clearly, referring to FIG. 4, on the basis of the embodiment as illustrated in FIG. 1, the instant messaging method may further include the following steps.

At S401, an operation of the user is monitored.

For example, the operation of the user may be a deletion operation, an encryption operation, a display operation, and so on.

Optionally, the operations of the user are monitored to perform different processing according to different operations.

At S402, when the deletion operation of the user on the notification message is monitored, the notification message is deleted from the notification bar Optionally, after all the useful notification messages are processed by the user, the deletion operation may be performed for the useless notification messages, to achieve the effect of fast processing of the notification messages and avoid the interference of the useless notification messages.

For example, when the user does not want to receive a group chat message, the deletion operation may be performed on the group chat message, or, when the text content of the notification message is short and the user knows the content of the notification message at a glance, for example, there is only one emoji, and the user does not want to make any reply, the deletion operation may be performed on the notification message, to achieve the effect of quickly reading and processing the notification bar message.

At S403, a restart message sent by an operating system of the electronic equipment during a restart process is received, and the notification message in the notification bar is cleared based on the restart message.

Since the application is running in the memory of the electronic equipment, when the electronic equipment is restarted, the memory of the electronic equipment itself can be released, and the application will be closed completely, at this time, the notification messages in the notification bar are cleared.

It should be noted that, there is no strict timing relationship between steps S401 and S403 in FIG. 4, which can be executed in parallel or in sequence, and is not limited here. For example, S401 may be executed first and then S403 may be executed, or S403 may be executed first and then S401 may be executed, or S401 and S403 may be executed in parallel, which is not limited here.

With the instant messaging method according to embodiments of the present disclosure, by monitoring the operation of the user, when the deletion operation of the user on the notification message is monitored, the notification message is deleted from the notification bar, which can achieve the effect of fast processing of the notification messages and avoid the interference of the useless notification messages. By receiving the restart message sent by the operating system of the electronic equipment during the restart process, the notification message in the notification bar is cleared based on the restart message, which can release the memory of the electronic equipment, and improve the efficiency of the electronic equipment.

In order to realize the above embodiments, the present disclosure also provides an instant messaging device.

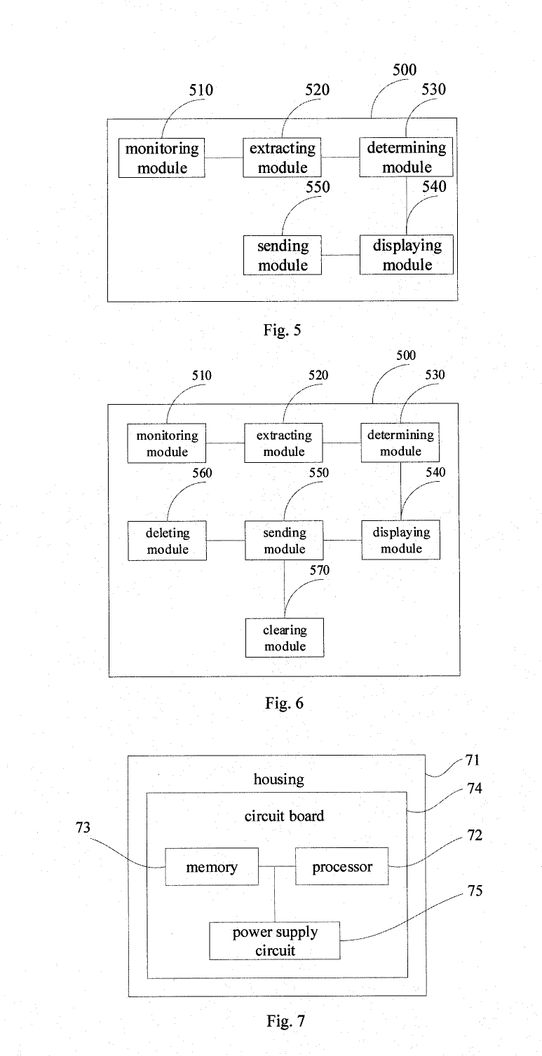

FIG. 5 is a block diagram of an instant messaging device according to embodiments of the present disclosure.

As illustrated in FIG. 5, the instant messaging device 500 is applicable to an electronic equipment in a screen locked state, and includes a monitoring module 510, an extracting module 520, a determining module 530, a displaying module 540, and a sending module 550.

The monitoring module 510 is configured to monitor a notification message in a message notification bar, in which the notification message comes from an application installed on an electronic equipment.

The extracting module 520 is configured to extract key information of the notification message from the monitored notification message.

Optionally, in a possible implementation of the embodiment of the present disclosure, the key information includes a message identification code of the notification message, a package name of the notification message, a data storage container of the notification message, text information of the notification message, and an action set of the notification message.

Optionally, in another possible implementation of the embodiment of the present disclosure, the key information further includes a tag of the notification message and/or a receiving time of the notification message.

The determining module 530 is configured to determine whether the notification message is a message requiring a reply according to the key information.

Optionally, to further improve social experience of the user, in a possible implementation of the embodiment of the present disclosure, the determining module 530 is specifically configured to determine whether an input action is included in the action set of the notification message, and if the action set includes the input action, determine the notification message to be a message requiring a reply.

The displaying module 540 is configured to, if the notification message is a message requiring a reply, display a reply interface for a user on the electronic equipment, in which the reply interface is independently configured and used to provide a uniform reply entry for multiple applications.

The sending module 550 is configured to generate a reply message to the notification message in the reply interface, and send the reply message to the application, so as to enable the application to send the reply message to an application of a receiving party.

Optionally, in a possible implementation of the embodiment of the present disclosure, the sending module 550 is specifically configured to obtain text information input by the user on the reply interface as the reply message, package the reply message into the data storage container, package the input action and the data storage container into the built sending intent, and send the reply message to the application based on the sending intent.

Further, in a possible implementation of the embodiment of the present disclosure, on the basis of FIG. 5, referring to FIG. 6, the instant messaging device 500 further includes a deleting module 560 and a clearing module 570.

The deleting module 560 is configured to monitor an operation of the user, and when a deletion operation of the user on the notification message is monitored, delete the notification message from the notification bar.

The clearing module 570 is configured to receive a restart message sent by the operating system of the electronic equipment during the restart process, and clear the notification message in the notification bar based on the restart message.

It should be noted that, the explanation of embodiments of the instant messaging method in FIGS. 1 to 4 described above is also applicable to the instant messaging device 500 of the embodiment and is not elaborated here.

With the instant messaging device according to embodiments of the present disclosure, by monitoring the notification message in the message notification bar, the key information of the notification message is extracted from the monitored notification message, whether the notification message is a message requiring a reply is determined according to the key information, the reply interface is displayed for the user on the electronic equipment if the notification message is a message requiring a reply, the reply message to the notification message is generated in the reply interface, and the reply message is sent to the application, such that the application sends the reply message to an application of a receiving party. In the embodiment, a uniform reply interface is provided for multiple applications, such that it is possible to quickly reply to notification messages from multiple applications, improving message processing efficiency, and improving the social experience of the user.

Embodiments of the present disclosure also provide an electronic equipment. The electronic equipment includes the instant messaging device described in any of the above embodiments.

FIG. 7 is a block diagram of an electronic equipment according to embodiments of the present disclosure, which can realize the procedure of the embodiments as illustrated in FIGS. 1 to 6 of the present disclosure. As illustrated in FIG. 7, the above electronic equipment may include: a housing 71, a processor 72, a memory 73, a circuit board 74 and a power supply circuit 75. The circuit board 74 is disposed in a space enclosed by the housing 71, the processor 72 and the memory 73 are positioned on the circuit board 74, the power supply circuit 75 is configured to provide power for respective circuits or components of the electronic equipment, the memory 73 is configured to store executable program codes, and the processor 72 is configured to run a program corresponding to the executable program codes by reading the executable program codes stored in the memory 73, to perform the instant messaging method described in the above embodiments.

With respect to the detailed execution procedure of the above steps by the processor 72 and the steps further executed by the processor 72 by running the executable program codes, reference can be made to description of the embodiments illustrated in FIGS. 1 to 4 of the present disclosure, which is not elaborated here.

The electronic equipment exists in a variety of forms, including but not limited to:

(1) Mobile communication equipment: this kind of equipment is characterized by the mobile communication function, and aims to provide voice and data communication. Such a terminal includes a smart phone (such as iPhone), a multimedia phone, a functional phone, and a low-end mobile phone.

(2) Ultra mobile PC equipment: such an equipment belongs to the category of personal computers, which have computing and processing functions and generally have mobile Internet access features. Such a terminal includes a PDA, a MID and a UMPC apparatus, such as an iPad.

(3) Portable entertainment equipment: such an equipment can display and play multimedia contents. Such an apparatus includes an audio player, a video player (such as ipod), a handheld game console, an e-book, and a smart toy and an portable on-vehicle navigation device.

(4) Server: an equipment that provides computing services, the server includes a processor, a hard disk, a memory, a system bus and so on. The server is similar to a general computer in architecture, however, due to the need of providing highly reliable services, there are higher requirements in processing capacity, stability, reliability, security, expandability, manageability and other aspects.

(5) Other electronic equipment with data interaction functions.

In order to realize the above embodiments, the present disclosure also provides a non-transitory computer readable storage medium, configured to store computer programs that, when executed by a processor, implement the instant messaging method according to the embodiments described in FIGS. 1 to 4.

In order to realize the above embodiments, the present disclosure also provides a computer program product. When instructions in the computer program product are executed by a processor, the instant messaging method according to the embodiments described in FIGS. 1 to 4 of the present disclosure is implemented.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means at least two, for example, two or three, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which functions can be not performed in an order as illustrated or discussed and can be performed in a substantially simultaneous manner or in a reverse order according to involved functions, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The storage medium mentioned above may be read-only memories, magnetic disks or CD, etc. Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. An instant messaging method, applicable to an electronic equipment in a screen locked state, the instant messaging method comprising:
monitoring a notification message in a message notification bar, wherein the notification message comes from an application installed on the electronic equipment;
extracting key information of the notification message from the monitored notification message;
determining whether the notification message is a message requiring a reply according to the key information;
if the notification message is a message requiring a reply, displaying a reply interface for a user on the electronic equipment, wherein the reply interface is independently configured and used to provide a uniform reply entry for multiple applications;
generating a reply message to the notification message in the reply interface, and sending the reply message to the application, such that the application sends the reply message to an application of a receiving party.

2. The instant messaging method according to claim 1, wherein the key information comprises a message identification code of the notification message, a package name of the notification message, a data storage container of the notification message, text information of the notification message, and an action set of the notification message.

3. The instant messaging method according to claim 2, wherein the key information further comprises a tag of the notification message and/or a receiving time of the notification message.

4. The instant messaging method according to claim 2, wherein determining whether the notification message is a message requiring a reply according to the key information comprises:
determining whether the action set of the notification message includes an input action;
if the action set includes the input action, determining the notification message to be a message requiring a reply.

5. The instant messaging method according to claim 4, wherein generating the reply message to the notification message in the reply interface, and sending the reply message to the application, comprises:
obtaining text information input by the user on the reply interface as the reply message;
packaging the reply message into the data storage container;
packaging the input action and the data storage container into a built sending intent;
sending the reply message to the application based on the sending intent.

6. The instant messaging method according to claim 1, further comprising:
monitoring an operation of the user;
when a deletion operation of the user on the notification message is monitored, deleting the notification message from the notification bar.

7. The instant messaging method according to claim 1, further comprising:
receiving a restart message sent by an operating system of the electronic equipment during a restart process, and clearing the notification message in the notification bar based on the restart message.

8. An instant messaging device, applicable to an electronic equipment in a screen locked state, the instant messaging device comprising:
a processor; and
a memory, configured to store instructions executable by the processor,
wherein the processor is configured to run a program corresponding to the instructions by reading the instructions stored in the memory, so as to:
monitor a notification message in a message notification bar, wherein the notification message comes from an application installed on an electronic equipment;
extract key information of the notification message from the monitored notification message;
determine whether the notification message is a message requiring a reply according to the key information;
if the notification message is a message requiring a reply, display a reply interface for a user on the electronic equipment, wherein the reply interface is independently configured and used to provide a uniform reply entry for multiple applications; and
generate a reply message to the notification message in the reply interface, and send the reply message to the application, such that the application sends the reply message to an application of a receiving party.

9. The instant messaging device according to claim 8, wherein the key information comprises a message identification code of the notification message, a package name of the notification message, a data storage container of the notification message, text information of the notification message, and an action set of the notification message.

10. The instant messaging device according to claim 9, wherein the key information further comprises a tag of the notification message and/or a receiving time of the notification message.

11. The instant messaging device according to claim 9, wherein the processor is configured to:
determine whether the action set of the notification message includes an input action;
if the action set includes the input action, determine the notification message to be a message requiring a reply.

12. The instant messaging device according to claim 11, wherein the processor is configured to:
obtain text information input by the user on the reply interface as the reply message;
package the reply message into the data storage container;
package the input action and the data storage container into a built sending intent;
send the reply message to the application based on the sending intent.

13. The instant messaging device according to claim 8, wherein the processor is further configured to:
monitor an operation of the user, and when a deletion operation of the user on the notification message is monitored, delete the notification message from the notification bar.

14. The instant messaging device according to claim 8, wherein the processor is further configured to:
receive a restart message sent by an operating system of the electronic equipment during a restart process, and clear the notification message in the notification bar based on the restart message.

15. An electronic equipment, comprising a housing, a processor, a memory, a circuit board and a power supply circuit, wherein, the circuit board is disposed in a space enclosed by the housing, the processor and the memory are positioned on the circuit board, the power supply circuit is configured to provide power for respective circuits or components of the electronic equipment, the memory is configured to store executable program codes, and the processor is configured to run a program corresponding to the executable program codes by reading the executable program codes stored in the memory, to perform an instant messaging method, the instant messaging method comprising:
monitoring a notification message in a message notification bar, wherein the notification message comes from an application installed on the electronic equipment;
extracting key information of the notification message from the monitored notification message;
determining whether the notification message is a message requiring a reply according to the key information;
if the notification message is a message requiring a reply, displaying a reply interface for a user on the electronic equipment, wherein the reply interface is independently configured and used to provide a uniform reply entry for multiple applications;
generating a reply message to the notification message in the reply interface, and sending the reply message to the application, such that the application sends the reply message to an application of a receiving party.
